(19) United States
(12) Patent Application Publication
(10) Pub. No.: US 2008/0098658 A1
(43) Pub. Date: May 1, 2008

(54) Two-Way, Horizontally Rotating and Self-Latching Gate Latch

(76) Inventor: Ezzat M. Niazy, Amelia, VA (US)

Correspondence Address: Alexander D. Raring, 536 Granite Avenue, Richmond, VA, 23226, US

(21) Appl. No.: 11/930,602

(22) Filed: Oct. 31, 2007

Related U.S. Application Data
(60) Provisional application No. 60/855,762, filed on Nov. 1, 2006.

(51) Int. Cl. E05B 65/06

(52) U.S. Cl. 49/394

(57) ABSTRACT

A gate latch with a two-way, horizontally rotating and self-latching operation is provided. The gate latch is mounted to a fence post or gate door post. A rotatable catch extends from the gate latch and is aligned in a closed position when the gate door is shut wherein the catch partially encloses a gate door or fence post when closed. The catch is latched or locked in place when aligned in the closed position in order to prevent the gate door from opening. Engaging a release switch allows the catch to rotate in a horizontal plane in either direction along an arc relative to the closed position (i.e., ‘two-way’ rotation). The catch remains in the open position until rotated to the closed position or the gate door is shut. The catch is automatically latched or locked into the closed position (i.e., self-latching) until the release switch is engaged. Optional locking mechanisms can prevent the operation of the release switch.

This application claims the benefit of U.S. Provisional Application Ser. No. 60/855,762 filed Nov. 1, 2006, which is hereby incorporated herein by reference.

The present invention relates to a gate latch for a fence gate. In more detail, the gate latch includes a two-way, horizontally rotating catch and provides a self-latching mechanism. The gate late also includes a spring assist and an actuatable release switch. In a preferred embodiment, the spring assist ensures a reliable self-latching mechanism.

### BACKGROUND

Gate latches are well known. Specific assemblies are built to solve various consumer needs. Perhaps the most common latch is a gate latch for a chain link fence. A chain link fence consists of a series of partially buried, vertical metal poles. The poles are arranged at fixed intervals. A mesh metal screen is secured to the poles so as to create a boundary. The area between any two poles can be left open so as to allow access to the fenced area.

A gate or door at the open portion selectively allows access to the fenced area. The gate comprises a gate door rotatably hinged to a first metal post. The gate door roughly spans the open space between the two vertical poles. Most commonly, the gate door includes a catch that moves between a vertical and a horizontal position. When the gate is closed, the catch is rotated from the vertical position to the horizontal position in order to at least partially encloses a second metal post. Once the catch is lowered, the second post prevents the door from rotating. By moving the catch to a vertical position, the door can once again be rotated to an open position. To lock the gate latch, a padlock lock hoop can be inserted through apertures in the catch and a collar on the gate door. The padlock prevents the catch from rotating.

This typical arrangement, however, includes several significant shortcomings. For instance, the catch may interfere with closing the door/gate. Children or pets may then be able to unexpectedly push the gate open. When closing the gate, the user has to carefully align the second post with the catch. This requires two-handed operation of the gate. This is undesirable for various reasons. The typical means to selectively lock the gate also requires a separate padlock. Other shortcomings are known to those of skill in the art.

Many state and local regulations require self-latching gate latch assemblies for swimming pool area. Consumers also desire a gate latch that is self-latching. However, known self-latching mechanism only allow the gate to open in one direction. Ideally, an improved self-latching mechanism would provide a secure latch while allowing the gate door to open in either direction. When the gate door would be closed with such a mechanism, the latch would also self-latch from both directions. This “two-way” self-latching gate latch would improve upon known mechanisms.

In addition, such an improved gate latch would ideally be retrofittable to existing chain link fences. The improved latch would simplify closing the gate door while providing a secure latch, and the latch would permit the door to swing open in either direction from the closed position. A spring assist could bias the catch open to ensure reliable operation of the latch, and an actuatable release switch would positively release the latch's catch in order to open the gate. The release switch would prevent children or pets from pushing the gate door open. An optional lock could prevent the release switch from moving at all.

An improved gate latch, as disclosed below, solves these and other long felt needs.

### SUMMARY OF THE PREFERRED EMBODIMENTS

In accordance with the detailed description of the preferred embodiments below, a gate latch with a two-way, horizontally rotating and self-latching operation is provided. The latch includes a catch that operates in conjunction with a self-latching mechanism. The mechanism includes a release switch that must be positively actuated to permit the rotation of the latched catch away from a closed position. An optional spring-assisted catch hinge encourages the catch to swing to a fully open position once that catch is rotated away from the closed position. The gate latch is automatically latched when the gate door is pushed to a closed position.

In at least one embodiment, the self-latching, fence gate latch for selectively securing a gate door comprises a housing secured to a first post. The housing comprising at least a top plate, a front plate, first and second sidewalls or otherwise creating at least a partial enclosure. A release switch is accessible to the exterior of the housing. The housing is connected to an anchor. A fence or gate door post is secured between the housing and anchor.

The slidable and selectively actuatable release switch extends from the housing. A moveable and spring-biased release plate is mechanically linked to the slidable release switch. Moveable release posts extend through the release plate wherein the movement of the release plate mobilizes the release posts. A latch plate above the release plate comprises at least two post holes corresponding to the release posts. The release posts selectively extend through the post holes provided by the latch plate and the upper face of the latch plate. The release posts are naturally biased through the latch plate. However, actuating the release switch causes the release posts to retract into the face of the latch plate or to be fully withdrawn from the latch plate.

A rotatable catch extends from the housing. The catch is operable to enclose a vertical fence or gate door post. The catch is rotatable along an arc in either direction normal to this second post's longitudinal axis. Basically, actuating the release switch permits the selective rotation of the catch from a closed position to an open position.

When the catch is in an open or unlatched position, at least one of the post holes in the latch plate is blocked. Blocking at least one of the post holes prevents each of the spring-biased release posts from extending through the upper face of the latch plate. The catch can be rotated so long as the release posts do not extend through the latch plate.

Closing the gate door rotates the catch to the “closed” or latched position. The release posts automatically extend through the latch plate when the catch is closed. The posts prevent the catch from rotating in either direction. This self-latching mechanism is released once the release switch is actuated. The catch rotates in either direction from the closed position when released.

The fence gate latch of may also include a catch hinge. The catch hinge is a rotatable mounting point for the catch. The catch hinge rotates about an arc in a plane normal to the longitudinal axis of the second post. The catch can move in either direction along the arc from the closed position. A spring assist biases the catch hinge towards an open position until the hinge hits a physical stop (i.e., the catch is fully open). When fully open, the catch is aligned to “grab” or enclose the second post when the gate door is closed. Again, when the door is pushed shut, the release posts extend through the latch plate preventing the rotation of the catch. The catch can then be selectively released via the release switch. The gate door opens in either direction, and the catch will self-latch when the door is pushed to the closed position.

In another embodiment, a locking plate can be included on the outside of the housing proximate to the release switch. A padlock or an internal lock mechanism can operate in conjunction with, or separate from, the lock plate to prevent the actuation of the release switch. In an alternative embodiment, a key lock and lock cylinder are used to actuate a lock bolt to prevent the actuation of the release switch.

The gate latch of the present invention effectively addresses at least one of the problems associated with prior art gate latches. For instance, the catch is always in a position to receive the fence post so that a user merely needs to move the door into the closed position. Operation of the gate latch is simplified and highly reliable. Once the door is in the closed position, the latch automatically secures the door. As such, operation of the gate door is one handed, or a user could even kick the door shut for “no-handed” operation for closing the gate latch. The need to engage the release switch precludes the possibility of a pet or child merely pushing the gate door open. Basically, a positive action must be completed to override the self-latching mechanism and open the gate door. The optional spring assist helps to ensure that the catch is in the best position to receive the fence post when moving from an open to a closed position. An optional locking mechanism could prevent the door from opening all together. The foregoing and additional features and advantages of the present invention will become apparent to those of skill in the art from the following detailed description of a preferred embodiment taken in conjunction with the accompanying drawings.

### BRIEF DESCRIPTION OF THE DRAWINGS

FIG. 1 is a perspective view of a gate latch in accordance with at least one preferred embodiment;

FIG. 2 is a perspective view of a gate latch in accordance with at least one preferred embodiment;

FIG. 3 is a perspective view of a gate latch in accordance with at least one preferred embodiment where the gate latch is in a closed position on a gate door;

FIG. 4 is a perspective view of a gate latch in accordance with at least one preferred embodiment where the gate latch is in a closed position on a gate door;

FIGS. 5a-5c are top plan view of a gate latch in accordance with at least one preferred embodiment where a gate catch is illustrated in both open and closed positions;

FIG. 6 is an exploded view of a gate latch in accordance with at least one preferred embodiment thereof; and

FIG. 7 is an exploded view of a gate latch in accordance with at least one preferred embodiment thereof.

### DETAILED DESCRIPTION OF THE PREFERRED EMBODIMENT(S)

The method and apparatus for operating and constructing a gate latch as disclosed herein efficiently address one or more shortcomings of the prior art. The present invention is retrofittable to existing fences and is thought to be more reliable, easier to operate, and safer than existing gate latch assemblies including, for instance, self-latching mechanisms that only allow a gate door to open in a single direction or that fail to provide a selectively actuated release switch to open the gate latch. The improved latch would provide one-handed or even “no-handed” operation for closing the gate door in a secure fashion.

An optional catch spring assist would ensure the catch is fully open so that the catch more reliably aligns with a post when the gate door is closed. The spring assist is intended to prevent the catch from closing while the gate door is an opened position. For safety, the actuatable release switch must be positively engaged to selectively release the catch from the closed position. However, the catch is automatically latched when the door/gate is pushed to a closed position. Independent locking of the release switch would further increase safety or otherwise prevents access to a fenced area.

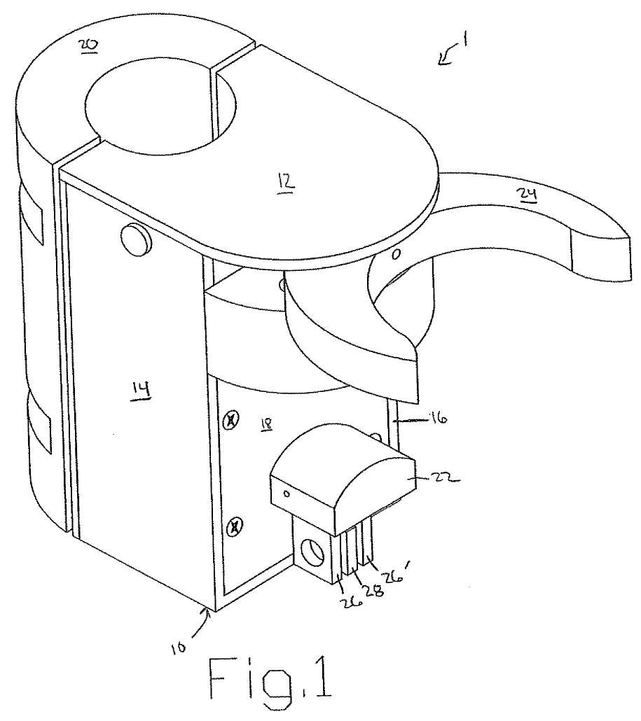

FIGS. 1 through 7 illustrate one or more preferred embodiments of the present invention. Naturally, an engineer having ordinary skill with the assembly of gate latches will be able to create a latch that incorporates the teachings of the present invention but which may look different and incorporate different, alternative parts.

One embodiment of a gate latch 1 as disclosed herein is illustrated in FIG. 1. The latch includes a main housing 10 comprising a top plate 12, a first sidewall 14, a second sidewall 16, and a front plate 18. Housing 10 creates a partial enclosure.

The housing is secured to an anchor 20. The size and shape of the housing assembly and anchor permits the secure placement of a fence or door post between the anchor and housing. Gate latch 1 can be retrofitted to existing gate doors or fence posts as needed. In light of the figures, the means to secure the gate latch on a fence or door post will be evident to one of skill in the art.

An actuatable release switch 22 extends from the housing. In a preferred embodiment, the release switch extends to the front side of the housing (i.e., it extends from or through front plate 18). The release switch may include one or more lock panels 26, 26′. A fixed lock plate 28 would then be included proximate to the panels. With the optional lock panels and lock plate, a user can place a padlock's (not illustrated) lock hoop through apertures provided in each of the lock panels and lock plate to prevent movement of the actuatable release switch.

A catch 24 includes two curved arms defining a substantially ‘C-shaped’ body. The catch also extends to the front of the gate latch and is partially covered by top plate 12. The catch is sized and dimensioned to accept a fence or door tubular post between the two arms defining the ‘C-shaped’ catch body.

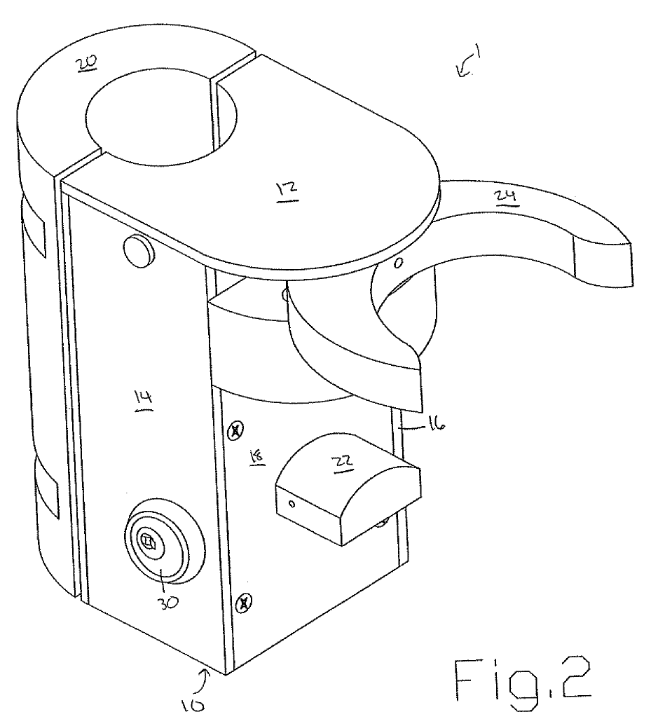

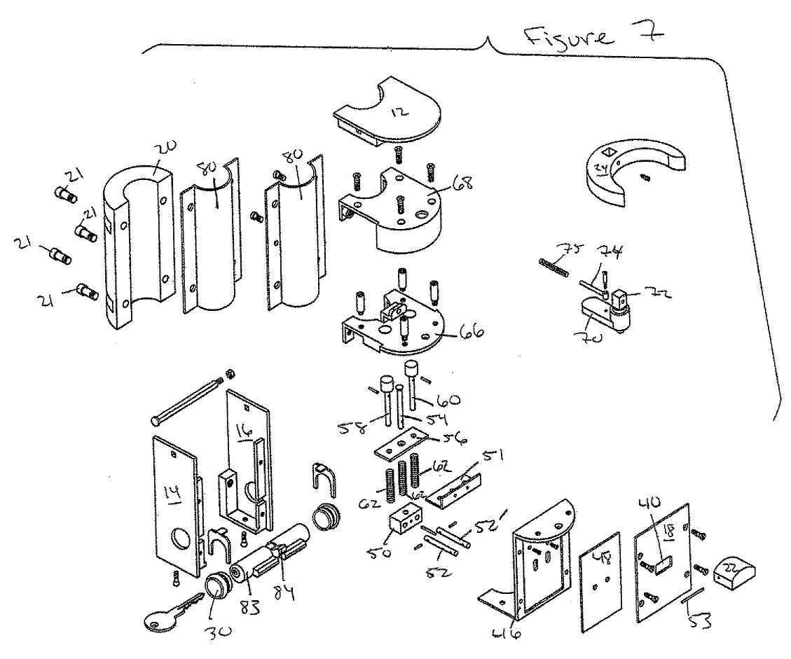

In another preferred embodiment, and with reference to FIG. 2, lock panels 26, 26′ and lock plate 28 are removed. Instead, a key lock 30 controls an internal locking mechanism (i.e., a lock cylinder, as discussed further below; see also FIG. 7), to prevent release switch 22 from being actuated. Either locking mechanism is intended to provide increased security and/or safety.

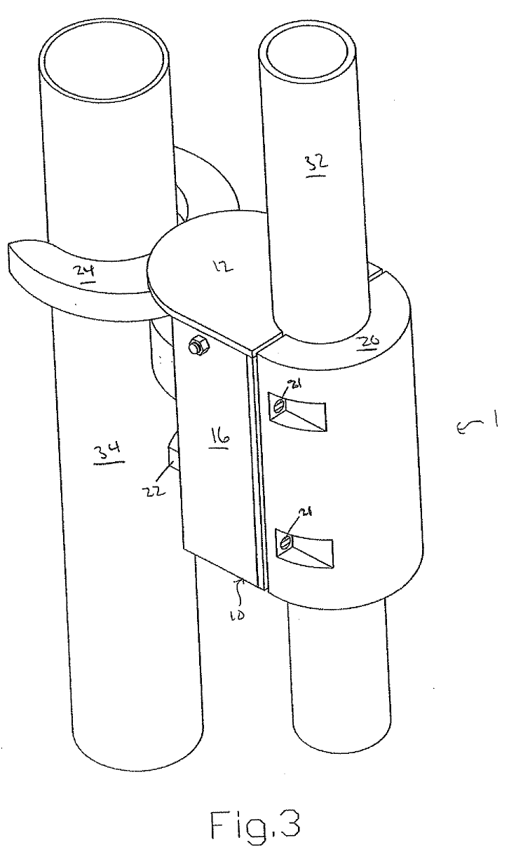

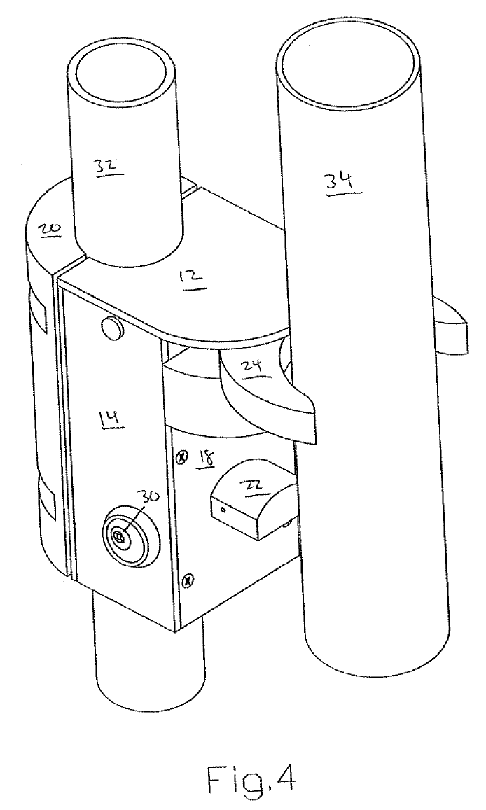

FIGS. 3 and 4 illustrate gate latch I installed onto a door post or fence post and latched to a corresponding door or fence post as would be found, for example, on a chain link fence. Housing 10 could be mounted to either a fence post so as to capture a door post within catch 24 or on a door post so as to capture a fence post within catch 24.

In a preferred embodiment, gate latch 1 is mounted on a door post 32. Generally, vertical door post 32 forms at least a portion of a gate or door frame, as would be understood by one of skill in the art. Chain linked metal or some other suitable material is covers the door frame as defined by the tubular posts. Hinges on one side of the gate door allow the door to rotate into or away from a fenced-in area. The gate latch is located on the side of the door opposite the hinges in order to selectively secure the gate door to a fence post in a closed position.

Here, door post 32 preferably fits between anchor 20 and housing 10. A plurality of anchor fasteners 21 secure anchor 20 to housing 10. When the gate door is closed, and as illustrated in at least FIGS. 3 and 4, fence post 34 is at least partially enclosed by the “C-shaped” body of catch 24.

The general operation of gate latch 1 is now broadly described. In use, catch 24 is automatically secured, latched, or otherwise fixed in place when a line intersecting the arc of the C-shaped catch is aligned with the longitudinal axis of gate latch 1. In other words, where catch 24 is in the closed position, as illustrated in FIGS. 3 and 4, gate latch I provides a self-latching mechanism in that catch 24 is selectively fixed in place. When the catch is in the closed position, the gate door is closed and door post 32 and fence post 34 are immediately proximate to each other. The catch is selectively unlatched to allow the gate door to open. Opening the gate door moves door post 32 away from fence post 34 relative to the closed position.

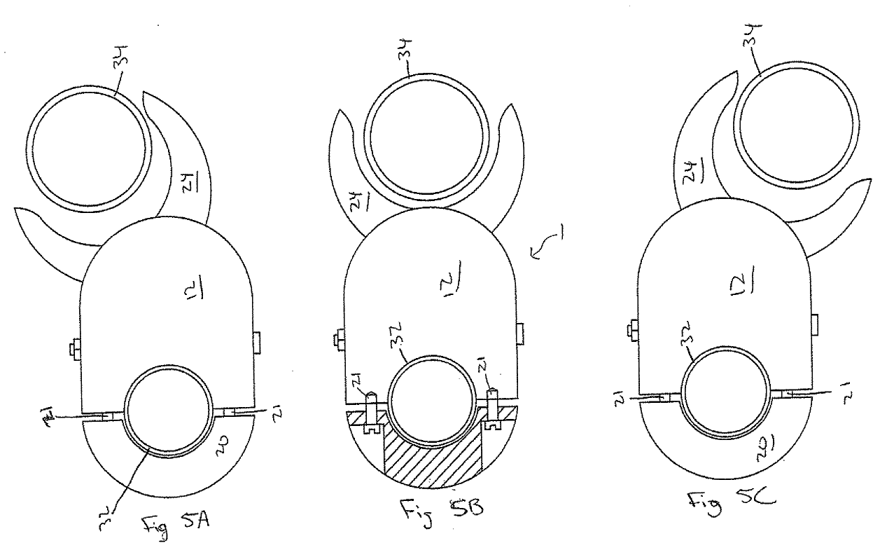

To open the gate door, release switch 22 must be engaged. While switch 22 is engaged, the gate door can be pushed in either direction. Catch 24 moves with gate latch 1 but rotates along an arc substantially opposite to arc the arc of rotation defined by the rotatable gate door (as described below; see also FIGS. 5A-5C). Any rotation of catch 24 away from the closed position means the catch is in an open position. Once in an open position, the catch is “unlatched” in that it is free to rotate. The catch remains unlatched and open until it is once again aligned into the closed position. An assist spring can ensure that the catch rotates to a fully open position or is otherwise held in an open position without unexpectedly rotating back to the closed position. A spring assist is intended to reliably align the catch with fence post 34.

To close the gate door, a user simply moves the door until door post 32 is immediately proximate to fence post 34. Fence post 34 engages catch 24 and causes catch 24 to rotate to the closed position. Once in the closed position, gate latch 1 self-latches the catch in place. Since the catch is self-latching, the door can be forcibly pushed or kicked towards the closed position. The gate door will not swing past the closed position. It reliably latches at the closed position. The gate door cannot be opened until a user actuates the release switch. The gate door can be opened in either direction while the switch is engaged. When the switch is released, the catch remains open and is freely rotatable towards the closed position.

Overall, operation of gate latch 1 provides a two-way operation in that the door can open in either direction. The catch rotates horizontally in two directions relative to the closed position. When opened in either direction, the gate latch will still automatically self-latch the catch when it is rotated back to the closed position.

FIGS. 5A-SC illustrate this operation from a top-down perspective. Fence post 34 has a longitudinal axis that would be normal to the cross-sectional plane illustrated in these figures. In FIG. 5A, the gate door and door post 32 are rotated along an arc extending to the right side of fence post 34 (i.e., clockwise from this top-down perspective). Catch 24, on the other hand, rotates along arc in a substantially opposite or counterclockwise direction. Stated another way, catch 24 rotates along an arc normal to the longitudinal axis of fence post 34. The catch is moving to the right along with door post 32, but catch 24 is simultaneously rotating along an arc defining a counterclockwise direction.

FIG. 5B illustrates gate latch 1 in the closed position. The distance between fence post 34 and door post 32 is at a minimum. A line intersecting the C-shaped body of catch 24 is aligned with the longitudinal axis of gate latch 1. The catch is latched until a user actuates the release switch.

FIG. 5C illustrates gate latch 1 and catch 24 in an open position where the gate door has been rotated along an arc to the left side of fence post 34 (i.e., counterclockwise from this top-down perspective). Moving the gate door in this direction leads catch 24 to rotate along a clockwise arc. Therefore, catch 24 is moving mainly to the left with gate post 32, but the catch's rotation is along an arc normal to the to the longitudinal axis of the fence post. The arc defines a clockwise direction from this top-down view.

As catch 24 is freely rotatable when not in the closed position, closing the door automatically rotates the catch back to the closed position of FIG. 5B. FIGS. 5A and 5C illustrate the two-way operation of the subject latch.

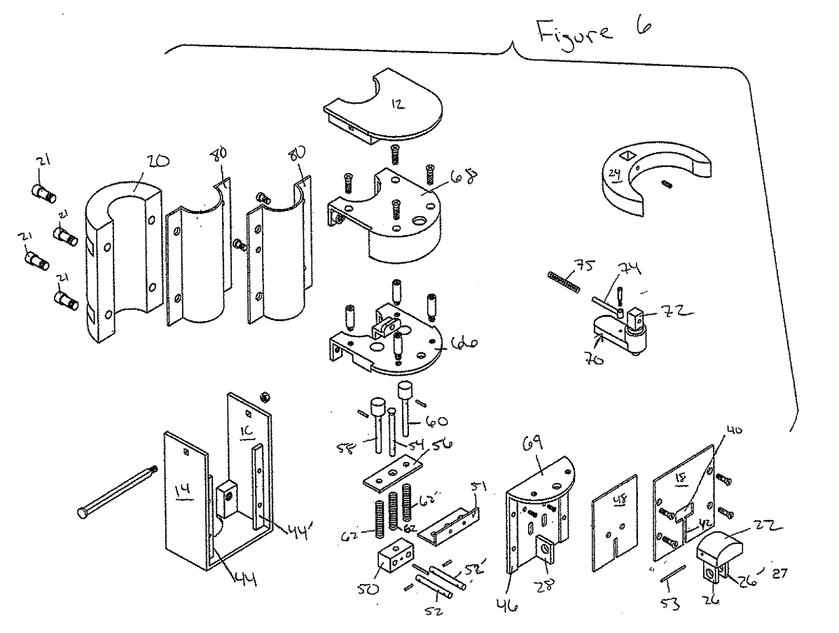

With an understanding of the basic operation of gate latch 1, reference is now made to the exploded illustrations of FIGS. 6 and 7. As previously described, a housing 10 comprises a top plate 12, first sidewall 14, second sidewall 16 and front plate 18. The housing at least partially encloses gate latch components. Front plate 18 includes a switch aperture 40 and lock channel 42. A backing plate 46 is placed behind front plate 18. Both the backing plate 46 and front plate 16 are secured to sidewalls 14, 16 of housing 10 via a plurality of fasteners (illustrated but not labeled). The fasteners pass through corresponding apertures in the front and backing plates. The fasteners are secured to fixed flanges 44, 44′ within housing 10. A slidable sandwich plate 48 is placed between front plate 18 and backing plate 46. A fixed ledge 51 is also secured by known means to the interior side of fixed backing plate 46.

Switch 22 is secured to a moveable block 50 by beams 52, 52′. The beams are inserted into apertures (not illustrated) in switch 22. A pin 53 transversely passes through switch 22 and both beams by aligning with apertures in beams 52, 52′. Beams 52, 52′ in turn pass through sandwich plate 48 and backing plate 46. The distal ends of the beams are secured to block 50 by known means. In use, a user actuates or engages switch 22 by pushing down on the switch (i.e., away from top plate 12). Beams 52, 52′ have a vertical travel path. Therefore, block 50 can be moved downwards or away from top plate 12.

A center post 54 is also connected to block 50 by known means and extends vertically upwards from block 50. Center post 54 passes through an aperture in fixed ledge 51 and then through a release plate 56. The upper end of center post 54 is sized so that it cannot pass through release plate 56. As such, the downward movement of block 50 is transmitted to release plate 56 via center post 54.

At least two release posts 58, 60 also extend through release plate 56 and are connected to or seat on fixed ledge 51 at their lower ends. The upper ends of release posts 58, 60 are sized so that they cannot pass through release plate 56. Once inserted through release plate 56, rivets, pins, or the like can be inserted through or otherwise attached to release posts 58, 60 at a point below release plate 56 to thereby fix release plate 56 in place on release posts 58, 60. Essentially, release plate 56 is fixed between the enlarged upper ends of the release posts and the associated pin, rivet, or the like.

Post springs 62 are located about each of the center 54 and release posts 58, 60. Post springs 62 are sandwiched between release plate 56 and fixed ledge 51 causing an upward bias on release plate 56 away from fixed ledge 51. This spring biased force pushes release plate 56 up towards top plate 12. As the release plate is mechanically linked to the block 50 and switch 22, the block and switch are also spring-biased upwards until the switch is engaged. Engaging switch 22 moves beams 52, 521 downwards. With switch 22 engaged, center post 54 transmits a downward force to release plate 56 sufficient to overcome the spring bias of post springs 62.

As disclosed above, switch 22 can be locked in place by threaded a padlock lock hoop through lock panels 26, 26′ and lock plate 28. Lock plate 28 is fixed in place. Once switch 22 is locked, catch 22 will not rotate to an open position, as further explained below.

The post springs 62 provide a natural upward spring bias against release plate 56. Engaging release switch 22 overrides this bias to provide a downward force to release plate 56. Any force on release plate 56 is transmitted to release posts 58, 60, the upper ends of which extend through a latch plate 66. Plate 66 is aligned horizontally with an upper and lower face. Latch plate 66 provides apertures through which the release posts selectively extend.

With switch 22 engaged, the upper ends of release posts 58, 60 can be selectively withdrawn beneath the upper face of latch plate 66. When switch 22 is disengaged, posts springs 62 cause the upward movement of release plate 56 and the corresponding upward movement of release posts 58, 60. Therefore, the upper ends of release posts 58, 60 extend through the upper face of horizontal latch plate 66.

Top plate 12 is located above latch plate 66. A catch plate 68 is placed between top plate 12 and latch plate 66. The catch and latch plates are joined or fastened together by known means, as will be evident to one of skill in the art in reviewing FIGS. 6 and 7. In addition, backing plate 46 includes a shelf 69 corresponding the front contours of catch and latch plates 68 and 66, respectively. Shelf 69, as would be evident to one of skill in art when considering the associate figures, provides a mounting point to secure the various plates to sidewalls 14, 16 of housing 10.

Catch 24 is rotatably mounted to a catch hinge 70. The catch is partially located between top plate 12 and catch plate 68. Catch hinge 70 is mounted to latch plate 66 and includes a catch post 72 that extends through catch plate 68 into a corresponding aperture (not labeled) in catch 24. Hinge 70 also includes an elongated tongue that is aligned with the longitudinal axis of gate latch 1 when the catch is in the closed position.

A spring assist arm 74 is also secured to catch hinge 70 approximately at the midpoint of the elongated tongue. Arm 74 can be secured to hinge 70 via a pin or other known fastening mechanism. The opposing end of arm 74 is secured to fixed bracket on latch plate 66 by known means. In a closed position, the axis of arm 74 is aligned with the longitudinal axis of hinge 70. As hinge 70 rotates away from the closed alignment, spring 75 applies biasing pressure to hinge 70 thereby encouraging the further rotation of hinge 70 away from the closed position. As such, any rotation of hinge 70 away from the longitudinal axis of gate latch 1 causes catch 24 to ‘pop’ or rotate into a fully open position. This is desirable as the spring assist holds catch 24 open and aligns catch 24 with fence post 34 when the gate door is closed.

Release posts 58, 60 extend through latch plate 66 to either side of the hinge tongue. This prevents the hinge from rotating when catch 24 is aligned in the closed position. The catch, in turn, cannot rotate. Thus, gate latch 1 is self-latching.

Actuating switch 22 to pull release plate 56, and thus release posts 58, 60, sufficiently downward withdraws release posts 58, 60 through the upper face of latch plate 66. With switch 22 engaged, hinge 70 and, accordingly, catch 24 are allowed to rotate to an open position. When open, the hinge tongue covers one of the apertures through which release post 58 or 60 extended. This prevents post springs 62 from biasing the release posts into latch plate 66 even when switch 22 is disengaged. Both release posts are secured to release plate 56 so that blocking one aperture in latch plate 66 prevents either post from limiting the movement of hinge 70.

Marginal pressure on the gate door is required to open the catch given the spring bias supplied by spring 75 and arm 74. Likewise, closing the door causes catch 24 to rotate to the closed position. This aligns the tongue of hinge 70 between the two release post apertures. The release posts are spring biased into a locking or self-latching position until release switch 22 is engaged.

One or more backing plates 80 are secured to catch plate 68 and anchor 20 in order to both enclose housing 10 and secure gate latch 1 to a post. Again, the specific structure of the housing 10 or latch 1 can be altered without deviating from the scope of the invention.

FIG. 7 differs from FIG. 6 in that lock panels 26, 26′ and lock plate 28 are removed. Instead, key lock 30 is operable to rotate a lock bolt 84 around the periphery of a lock cylinder 83. When lock bolt 84 extends vertically upward from the cylinder of key lock 30, it prevents the downward motion of block 50. Therefore, catch 24 cannot be opened as hinge 70 is fixed between release posts 58 and 60. Switch 22 cannot be actuated until key lock 30 is “unlocked”. In other words, lock bolt 84 is rotated to a horizontal position thereby releasing block 50 to move downward from the naturally spring biased position. Lock bolt 84 is illustrated in FIG. 7 halfway between a horizontal and vertical position While the invention has been described with reference to specific embodiments thereof, it will be understood that numerous variations, modifications and additional embodiments are possible, and all such variations, modifications, and embodiments are to be regarded as being within the spirit and scope of the invention.

1. A self-latching, fence gate latch for selectively securing a gate door,: the gate latch comprising:
a housing secured to a first fence post, the housing comprising a top plate, a front plate, first and second sidewalls creating at least a partial enclosure, the housing connected to a first post;
a selectively actuatable, spring-biased release switch extending to the exterior of the housing;
a moveable and spring-biased release plate mechanically linked to the release switch;
at least two moveable release posts, the posts extending through the release plate wherein the movement of the release plate mobilizes the release posts;
a latch plate comprising at least two post holes corresponding to the release posts, the release posts selectively extending through the post holes provided by the latch plate;
a rotatable catch extending from the housing, the catch operable to enclose a second post when placed in a closed position, the second post having a longitudinal axis, the catch rotatable in either direction along an arc normal to the post axis; and
wherein actuating the release switch permits the selective rotation of the catch from a closed position to an open position.

2. The fence gate latch of claim 1, wherein the first post further comprises a post forming a portion of a fence gate door.

3. The fence gate latch of claim 1, wherein the front plate further comprises a release switch aperture;
at least one horizontal beam extending from the release switch, the at least one beam mechanically connected to the release plate; and
wherein engaging the release switch moves the at least one beam and the release plate vertically downward.

4. The fence gate latch of claim 3, wherein the downward movement of the release plate retracts the release posts through the latch plate thereby permitting the selective rotation of the catch from a closed position to an open position.

5. The fence gate latch of claim 4, wherein disengaging the release switch and aligning the catch in a closed position selectively prevents the rotation of the catch.

6. The fence gate latch of claim 1, wherein the catch is secured to a rotatable hinge, the hinge rotatable about an axis normal to the second post, a hinge assist spring providing a spring biasing force to the hinge operable to bias the catch away from the closed position.

7. The fence gate latch of claim 1, wherein a locking plate is proximate to the release switch, the locking plate adapted for use with a pad lock to prevent the movement of the release switch.

8. The fence gate latch of claim 1, wherein a lock cylinder is operable to prevent the movement of the release switch.

9. A self-latching, fence gate latch for selectively securing a gate door, the gate latch comprising:
a housing secured to a vertical post, the post forming a portion of a rotatable gate door;
a selectively actuatable release switch extending from the housing, the release switch actuatable in a vertical, downward direction;
at least two moveable release posts, the posts mechanically linked to the release switch and moveable in a vertical, downward direction;
a horizontal latch plate with an upper face and a lower face, the latch plate including at least two post holes corresponding to the release posts, the release posts selectively extending through the post holes and upper face provided by the latch plate;
a rotatable catch extending from the housing, the catch operable to enclose a second fence post when placed in a closed position, the second post having a longitudinal axis, the catch rotatable in either direction along an arc normal to the post axis; and
wherein actuating the release switch permits the selective rotation of the catch from a closed position to an open position.

10. The fence gate latch of claim 9, wherein the downward movement of the release posts is sufficient to retract the release posts through upper face of the latch plate thereby permitting the selective rotation of the catch from a closed position to an open position.

11. The fence gate latch of claim 10, further comprising at least one spring to cause an upward spring bias force on the release posts and release switch, wherein disengaging the release switch with the catch aligned in a closed position causes the release posts to extend through the upper face of the latch plate thereby preventing the rotation of the catch.

12. The fence gate latch of claim 11, wherein the catch is secured to a rotatable hinge, the hinge rotatable about an axis normal to the second post, a hinge assist spring providing a spring biasing force to the hinge operable to bias the catch away from the closed position.

13. The fence gate latch of claim 12, wherein a locking plate is proximate to the release switch, the locking plate adapted for use with a pad lock to prevent the movement of the release switch.

14. The fence gate latch of claim 12, wherein a lock cylinder is operable to prevent the movement of the release switch.

15. A gate latch assembly comprising:
a rotatable gate door, the gate latch assembly mounted on the gate door;
a selectively actuatable release switch, the release switch actuatable in a vertical, downward direction;
at least two moveable and upwardly spring biased release posts, the posts mechanically linked to the release switch and moveable in a vertical, downward direction;
a catch rotatably mounted on a selectively rotatable hinge, the catch extending from the gate latch, the catch operable to at least partially enclose a fence post, the catch being aligned in a closed position when the gate door is closed, the release posts preventing the rotation of the catch hinge when the catch is aligned in the closed position; and
wherein engaging the release switch overcomes the upward spring bias applied to the release posts thereby moving the release posts downward so that the catch hinge is rotatable when the catch is in the closed position.
